(19) United States
(12) Patent Application Publication
(10) Pub. No.: US 2012/0305533 A1
(43) Pub. Date: Dec. 6, 2012

(54) FORCED FREEZE WELDING OF ADVANCED HIGH STRENGTH STEELS

(75) Inventor: Robert P. Matteson, Warren, OH (US)

(73) Assignee: Taylor Winfield Technologies, Inc.

(21) Appl. No.: 13/151,875

(22) Filed: Jun. 2, 2011

(51) Int. Cl. B23K 11/04; B23K 11/00

(52) U.S. Cl. 219/97; 219/117.1

(57) ABSTRACT

In a force freeze welding method and system for joining metal work pieces, a controlled and programmable electrical potential is applied to a circuit including a first work piece (130) and a second work piece (140). The first work piece (130) is linearly translated towards the second static work piece (140) to engage along a faying interface (190). The first work piece (130) and the second work piece (140) move together at a controlled rate and voltage is applied to the circuit which produces heat to soften or plasticize the faying interface (190) during a flashing stage (310). A position offset (210) or abrupt compression force is applied to at least one of the first work piece (130) and the second work piece (140) prior to applying an upset (330) to force the first work piece (130) and the second work piece (140) together to weld the first work piece (130) and the second work piece (140) along the faying interface (190).

### BACKGROUND

The present application relates to a method of flash welding. More particularly, it finds application in conjunction with the flash welding of advanced high strength steels (AHSS), and will be described with particular reference thereto. However, it is to be appreciated that the described technique is also amenable to other applications.

Flash welding is a resistance method of welding in which edges of two work pieces are accurately positioned in close proximity in spaced relation with respect to each other. At least one work piece is then moved relatively slowly toward the other while electrical potential is applied to cause an arc or flashing between the edges of work pieces to heat and soften the material. Once softened the edges of the work pieces are compressed against one another and then caused to “upset” or impact under considerable pressure while high amperage current flows across the compressed edges to fuse and weld them together. The upset stage includes rapid and complete intimate contact between the first and second work pieces, along with some additional displacement, such that a portion of material is extruded along the edges.

During a normal flash welding operation, the current flowing between the edges of the work pieces has a rather low relative value when flashing takes place. When the work pieces are upset, the current flowing in the work pieces is much greater than that evidenced during flashing.

Flash welding has been used to join rails for railroads, coils of steel for processing in pickle and cold reduction lines, automotive parts, rings for aircraft engines, bandsaw blades and a wide variety of parts. The material being flash welded can be ferrous or non-ferrous. However, with the introduction of work pieces made of advanced high strength steel (AHSS) grades, the heating rate during flashing and upsetting has a significant effect upon the characteristics of the weld. AHSS has become more widely used as the automotive industry demands high strength, high alloy content materials. AHSS work pieces have proven to be more difficult to weld together using these conventional flash welding techniques. Particularly, AHSS grades are generally categorized by tensile strength while the quality of weld is a function of chemical makeup of the steel. This issue causes difficulties using conventional welding techniques because one work piece may have a different chemical composition than another work piece of the same grade. The high carbon-equivalent (Ceq) of AHSS results in the formation of Martinsite in or near the weld which results in a brittle region that can lead to failures. In some applications, such as pickle lines, the AHSS coils can be interposed with low Ceq coils to dilute the Ceq and reduce the martinsite formation. This technique is called checker boarding. While checker boarding is effective, it is more desirable to weld AHSS coils to themselves. Applications such as band saw blades don't permit the use of the checker boarding technique.

Ceq=C+(Mn+Cu+Cr)/20+Si/30+Ni/60+Mo/15+V/10+(5*B)

Note: This is one of several formulas for calculating Carbon Equivalent and applies for many sheet steel materials.

Those skilled in the art have attempted alternate methods including utilizing laser welding assemblies and processes to remedy this issue. Laser welds are perceived to provide a high quality weld with reduced weld breakage in AHSS work pieces. However the laser machinery is very costly and post weld tempering is often required due to martinsite formation and the lack of any upsetting to displace it. Therefore, there is a need to provide a method and a system to structurally join AHSS work pieces having a high quality weld. Further, there is a need to provide an improved flash welding method to existing assemblies as an alternate to the more costly laser welding methods.

### SUMMARY

This application relates to a flash welding method for joining metal work pieces using motor-driven cams, analog devices, or digital devices to create position vs. time profiles of the work pieces. The method includes applying a settable electrical potential to a circuit including a first work piece and a second work piece to heat and soften the work pieces at a faying interface. The first work piece is accelerated towards the second work piece along a position path at a predetermined rate. The first work piece is temporarily offset from the position path in relation to the second work piece. The first work piece is then upset against the second work piece along the position path thereby effecting an intermixing and forging or bonding of the first work piece and the second work piece along the faying interface. The present disclosure is a method to force freezing of the work pieces during a flashing stage at a programmable point in the flashing time and with a programmable forward motion (or offset) of the first work piece. The offset of time vs position is maintained while continuing to move the movable part toward the fixed part along the previous flashing path until the desired upset temperature is achieved. Freezing is a solid interface mating of the work pieces that can occur prior to upset. The term ‘freezing’ in flash welding is generally considered highly objectional. Forcing the freezing to occur is novel, but produces repeatable effects when performed under accurate and settable conditions.

In another embodiment, a flash welding method for joining metal work pieces comprises controlling a positioning assembly for aligning a first work piece with a second work piece along a faying interface, the positioning assembly including at least a first platen (with clamps) for securing the first work piece, a second static platen for securing the second work piece, the positioning assembly biasing the first work piece towards the second work piece along a position path. A controlled electrical potential is introduced to a circuit including at least the first work piece and the second work piece. The position of a first surface of the first work piece is controlled to abuttingly engage a second surface of the second work piece. The position assembly is controlled to provide an offset compressive force to the first work piece while abutting the second work piece along the faying interface before an upset compressive force is applied along the position path. Material is extruded along the haying interface such that any void space is reduced and effecting an intermeshing and bonding of the first work piece and the second work piece along the faying interface. Excess material can then be removed from a weld joint.

A system of flash welding metal work pieces together comprising a positioning assembly including a translation device operable to linearly translate a first platen securing a first work piece toward a second static platen securing a second work piece along a common plane. An electrical circuit including at least the first work piece, the second work piece and an associated power source to produce an electric potential. A processor programmed to control the positioning assembly, the electric potential, and the rate of acceleration along the position path.

One advantage resides in quaity, high strength welds of AHSS work pieces.

Another advantage resides in cost effectiveness.

Another advantage resides in compatibility with existing steel handling equipment.

Still other features and benefits of the present disclosure willbecome apparentfrom the following detailed descriptions.

### BRIEF DESCRIPTION OF THE DRAWINGS

FIG. 1A is a schematic graph of a prior flash welding process;

FIG. 1B is a schematic graph of a prior flash welding process;

FIG. 1C is a schematic graph of a prior flash welding process;

FIG. 2A is a schematic graph of one embodiment of the method of welding according to the present application.

FIG. 2B is a schematic graph of one embodiment of the method of welding according to the present application.

FIG. 2C is a schematic graph of one embodiment of the method of welding according to the present application.

FIG. 3 is a plan view of a clamping assembly with a first work piece aligned with a second work piece;

FIG. 4 is a plan view of the clamping assembly which the first work piece abutting the second work piece during a flashing stage;

FIG. 5 is a plan view of the clamping assembly which the first work piece abutting the second work piece during an offset stage;

FIG. 6 is a plan view of the clamping assembly which the first work piece abutting the second work piece during an upset stage;

FIG. 7 is a plan view depicting the removal of excess material from a haying interface;

FIG. 8 is a flowchart of one embodiment of a controller;

FIG. 9 is a flowchart of a method of flash welding according to the present application;

FIG. 10A is a schematic graph of one embodiment of the method of welding according to the present application;

FIG. 10B is a schematic graph of one embodiment of the method of welding according to the present application;

FIG. 10C is a schematic graph of another embodiment of the method of welding according to the present application.

### DETAILED DESCRIPTION

In accordance with the present disclosure, a method and system for flash welding materials is provided. Flash welding is well known resistance welding method in which coalescence is produced over the entire area of abutting surfaces. This coalescence, or extruded material, is caused by heat and obtained from the resistance to an electric potential flowing between the materials to be welded and the pressure exerted on them. The flash welding process typically includes two main stages: a flashing stage and an upset stage.

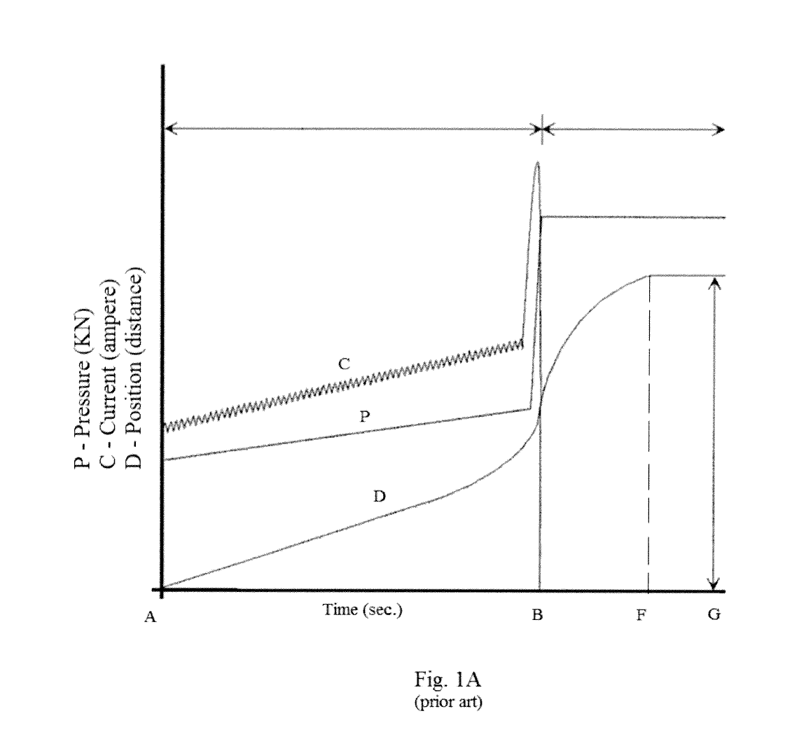

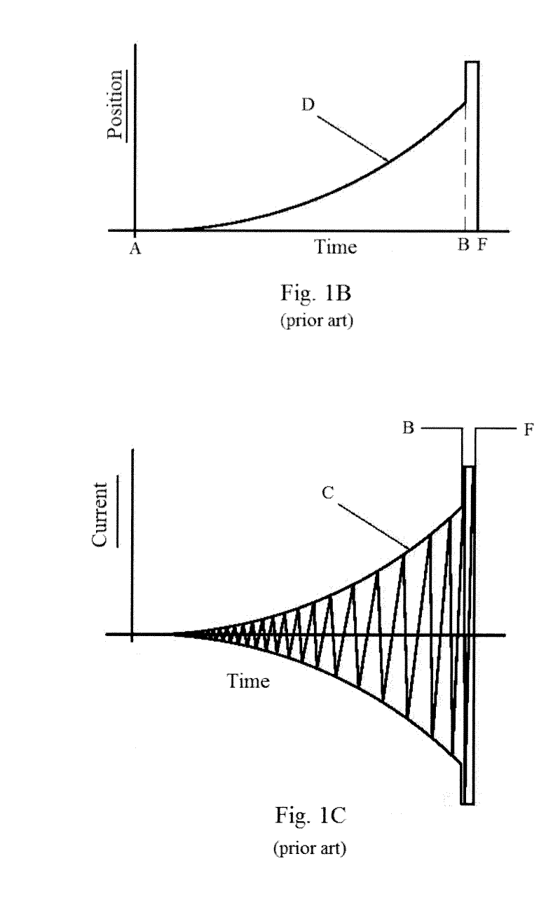

With reference to FIG. 1A, illustrated is a schematic graph of a typical flash welding process. The abscissa is representative of time (seconds) while the ordinate is representative of pressure P (kN), current C (ampere) and position (distance) of a first work piece relative to a second work piece to be flash welded and joined along a faying interface. Additionally, the ordinate of FIG. 1B is representative of position D while the ordinate of FIG. 1C is representative of current C for another embodiment of a prior art flash welding process. The faying interface generally includes the local area surrounding a first surface of the first work piece and the second surface of the second work piece and any space in between. The origin indicates the point in time ‘A’ when the flashing stage begins. Point ‘B’ represents the point in time when the upset stage begins and the flashing stage ends.

During the flashing stage A-B, a current passes through the faying interface of the first and second work pieces at an increased rate as represented by curve C. The current heats the material to be welded to cause plasticity of the material at the faying interface. As indicated, the current generally increases during the flashing stage between point A and point B due to acceleration of the movable work piece and because flashing rate increases with increased temperature. Generally, the current increases naturally during the entire flashing period. When the temperature of the metal at the interface, along with the temperature profile extending toward the clamps is achieved, upset occurs. During upset, current flow is usually maintained to allow the full desired value of upset dimension. Then, the current is reduced to zero. Pressure is then constantly applied at an elevated level during the upset stage.

Prior to point A, the first work piece is linearly translated towards a second work piece in a controlled and constant linear rate of speed. As the first and second work pieces move closer, arcing occurs at the faying interface. This linear approach is used to burn-off any mis-setting of the materials in the clamps prior to zero time of the flashing action. When zero flashing time is reached, the movable work piece accelerates along the pre-programmed flashing curve. This displacement is represented by the position curve D at the beginning of the upsetting stage. During the flash stage, material is heated to a plastic-like state. During the upset stage, rapid and complete intimate contact occurs between the first and second work pieces such that some of the plastic state metal is extruded from the faying interface as the first work piece is accelerated into the second work piece. When the current increases, the elevated heat of the faying interface increases the plasticity or fluid phase of the material causing the first work piece to advance more rapidly while extruding or displacing material on the faying interface. The current, pressure and position are provided in the predetermined manner described to ensure that certain materials including molten metal, oxides, and other impurities are extruded from the edges of the work pieces to be joined creating a satisfactory weld.

The upset stage and the extrusion of material occurs between B and F by which time the faying interface has cooled below the plastic state. The pressure is held until time G when the metal has become stable.

However, the prior art method described above has proven disadvantageous when combining materials having similar tensile strength but dissimilar chemical makeup and generally having a high carbon-equivalent. More particularly, the contemporary method of flash welding advanced high strength steel alloys (AHSS) has been found to produce inconsistencies in the quality of the welds.

The present method and system provides a consistent quality of weld by combining features of the flash welding process with features of a butt welding process. Here, the first work piece is linearly translated along a plane towards a static second work piece with a controlled and programmable acceleration as it is translated along a predetermined position path. The acceleration includes an abrupt compressing motion or offset of the first work piece against the second work piece between the flashing stage and the upset stage.

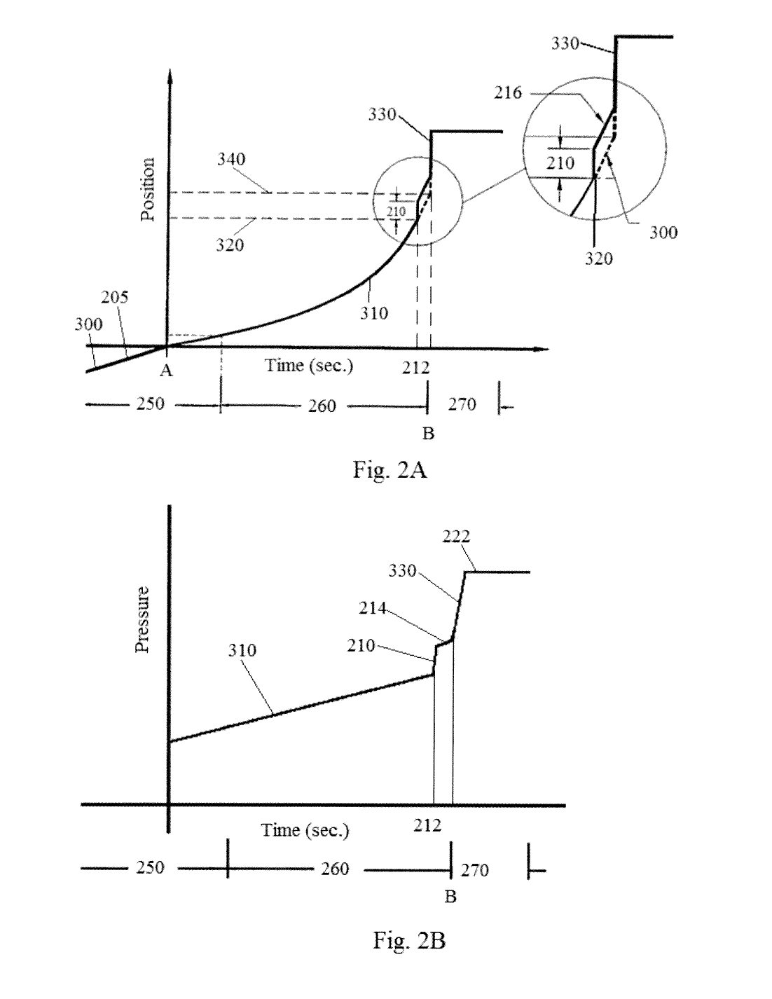

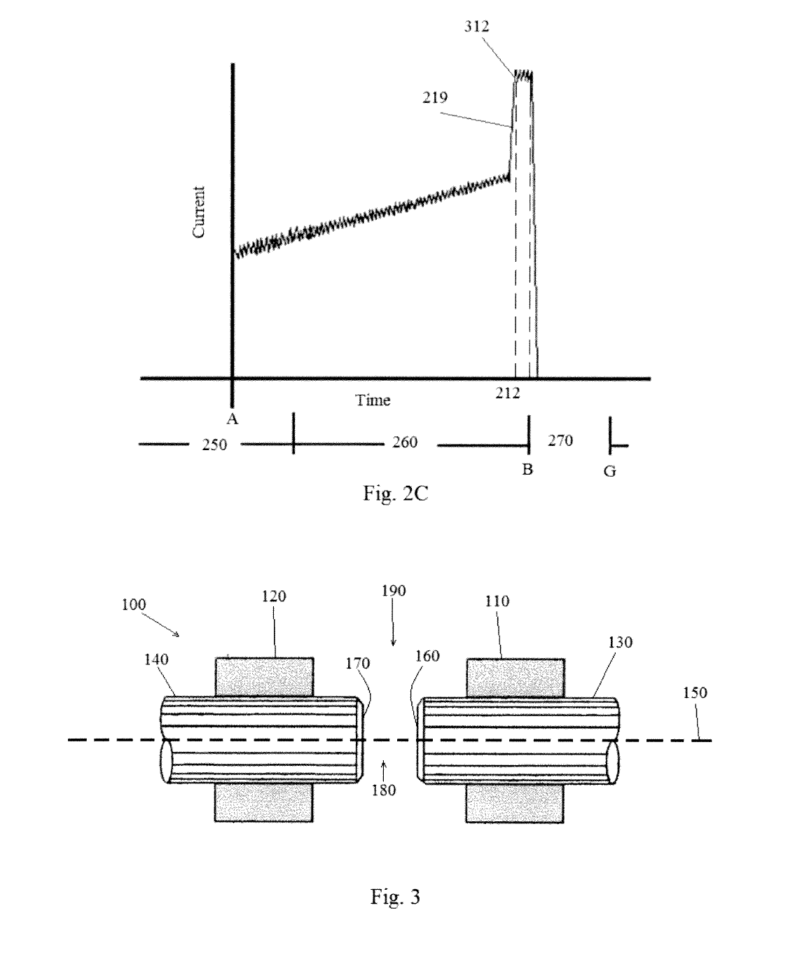

As shown in FIG. 2A, a time vs. position graph profiles the position of a first work piece 130 as it is abruptly offset 210 in a controlled manner from a predetermined position path 300 in relation to a second work piece 140. The graphs illustrated in FIGS. 2A-2C are representative of the displacement of a positioning assembly 100 and the applied current and pressure as the work pieces process through the positions depicted in FIGS. 3-8.

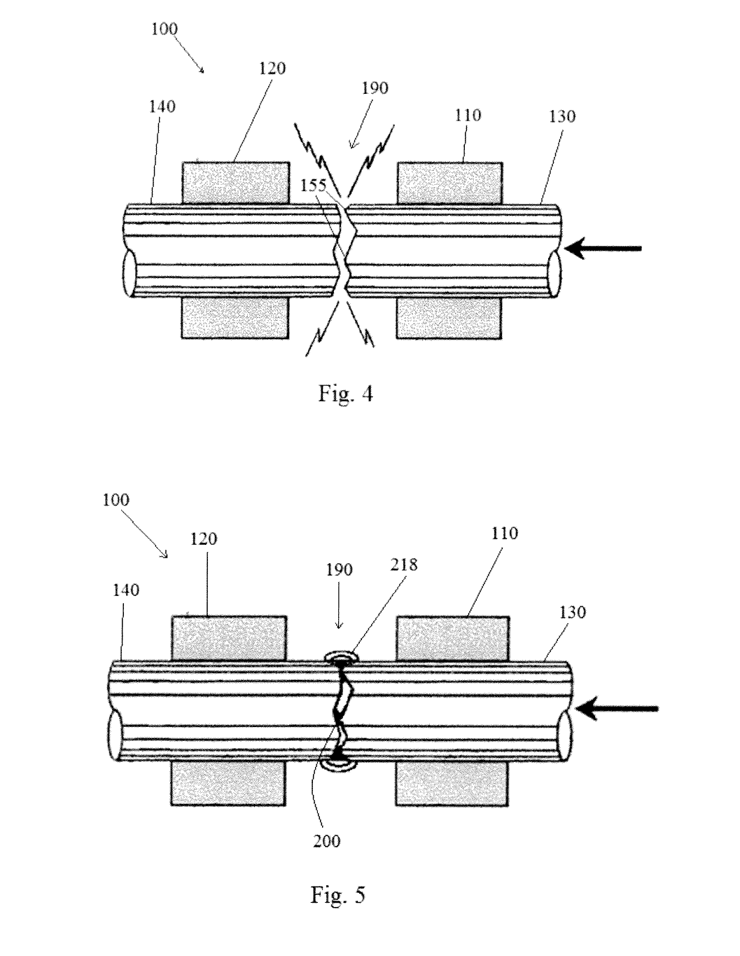

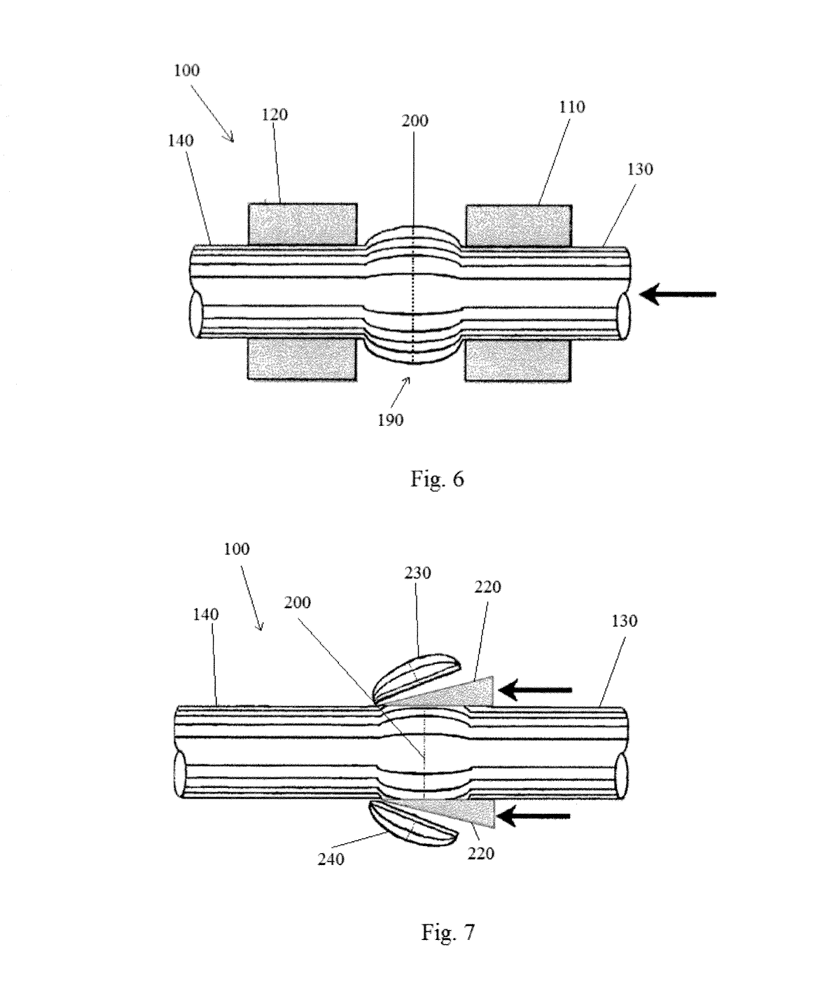

A flashing stage 310 (FIG. 4) is followed by an offset stage 210 (FIG. 5) which is followed by an upset stage 330 (FIG. 6). The amount of pressure and electrical potential exerted as well as the duration of each stage is programmable and controllable and is determined as a function of the material size and chemical makeup of the work pieces. The offset stage 210 includes an additional compressive force that is programmed to occur at an adjustable set point 320 on a predetermined position path 300 at a time of significant plasticity of the material to force the work pieces into full contact which may squeeze a small amount of material 218 out of a faying interface 190 and ensure that inconsistencies in the structural and chemical makeup of a weld joint 200 are reduced. More particularly, the amount of interface material 218 that is extruded due to the offset stage 210 is approximately 0.125 mm to 0.625 mm (0.005 in. to 0.025 in.) from the surface of the work pieces such that void spaces are eliminated or reduced and the material of both work pieces are substantially continuous.

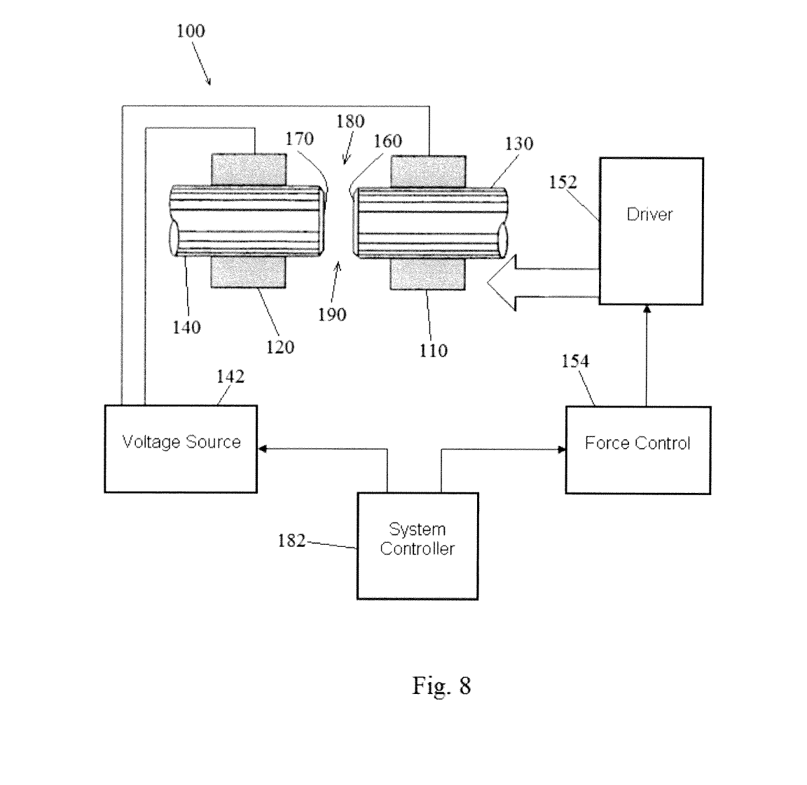

As shown in FIG. 3, the positioning assembly 100 includes a first platen 110 and a second static or fixed platen 120 that individually secures a first work piece 130 and a second work piece 140, respectively. The first and second platens can be secured to the work pieces in an electrically insulated way. An adjustable or variable voltage source 142 (FIG. 8) is configured to provide an electrical potential to the individual work pieces from an associate source. The first and second work pieces are generally aligned about a common plane 150 and have similar dimensional tolerances including both thickness and width. The system and method described can also be utilized to join work pieces having dissimilar dimensions and tolerances.

The first work piece 130 is rigidly clamped by the first platen 110 and the second work piece 140 is rigidly clamped by the second static platen 120. A first surface 160 of the first work piece 110 is positioned to face a second surface 170 of the second work piece. The first and second surfaces are separated by an air gap 180. A system controller 182 controls the voltage source 142 to apply an electric potential across the work pieces 130, 140 and controls a pressure controller 154 and a driver 152 to start moving the platens and work pieces toward each other. The driver 152 in one embodiment is a hydraulic cylinder and the pressure controller includes a hydraulic fluid supply and pump. More particularly, the electric potential is introduced to a current path or circuit comprising the first work piece 130, the second work piece 140 and the air gap 180. The localized area at the first surface 160 and the second surface 170 include the faying interface 190 where the flash welding occurs.

In one embodiment, as illustrated in FIG. 4, the first work piece 130 is linearly translated 205 (FIG. 2A) towards the second work piece 140. The air gap 180 is reduced by the system controller 182 and the current increases greatly due to reduction of the circuit impedance. The amount and timing of the platen position are controlled and as a function of the work piece material thickness, surface area, chemical makeup of the work pieces and amount of pressure applied to the work pieces. The first platen 110 is linearly advanced or translated along the plane 150 towards the second static platen 120. The first platen 110 is advanced until the air space 180 is sufficiently reduced that current arcs across the air space and a circuit or current path is completed. The circuit is completed when light contact is made or near contact occurs between one or more small protuberances 155 on the first surface 160 and second surface 170. The flashing stage 310 begins at time A and the current arcs between the first surface 160 and second surface 170 causing the faying interface 190 including the local area behind the first and second surfaces 160, 170 to increase in temperature. Once arcing starts, the electric potential and circuit resistance are reduced to a lower magnitude of voltage and resistance, respectively. However, the reduced resistance causes an increased magnitude of current draw while the magnitude of voltage is reduced. See FIG. 2C. The amount of voltage and current applied during the flashing stage 310 can be increased at a rate appropriate to the type and size of work pieces. Optionally, the voltage can be maintained while the current increases naturally due to the accelerated platen, raise in temperature, and increased ionization of the gaseous material in the interface region.

The motion of the first platen 110 is continued along the plane 150 while maintaining alignment between the first work piece 130 and the second work piece 140. The system controller 182 causes the driver 152 to advance such that the rate of travel of the first platen 110 is accelerated along the controlled and predetermined position path 310. Material of both first and second work pieces 130, 140 adjacent the faying interface 190 becomes sufficiently heated to assume a semi-plastic state.

With reference to FIGS. 2A-2C, 5, and 8 when the work pieces touch, the system controller 182 causes the driver 152 to abruptly increase the pressure force causing the work pieces to move rapidly together 210 at a programmable time 212 along the position path 310. The flashing stage is illustrated to begin at point A until the offset stage 210 occurs at programmable time 212, e.g. 4-22 seconds after point A. The force or pressure level is increased 214 causing the first work piece 130 into full contact with the second work piece 120. Deformation begins to occur along the faying interface 190 intermixing and forging of the plasticized fayed interface 190.

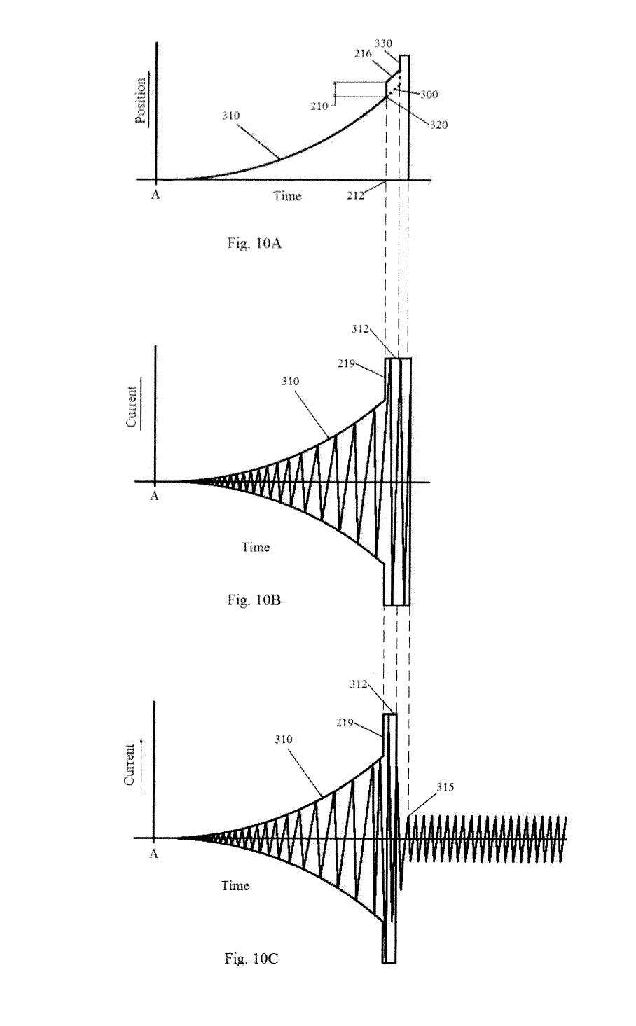

During the offset 210, as indicated in FIGS. 2A, 2C, 10A and 10B, current flow is substantially increased 219 to rapidly heat the faying interface 190. The offset 210 is scheduled to occur at a predetermined time 212 prior to an upset stage 330. In one embodiment, the offset 210 is programmed to occur to the end of the flashing stage 310. Generally, the offset 210 is programmed to occur between 4 to 22 seconds after contact is made between the first and second work pieces. The initiation of the offset 210 may occur at approximately 93%-98% of the flashing stage 310 time. In one embodiment, the current is increased 312 contemporaneously with the offset 210 and continues at the increased level 312 in the upset stage 330. The current increase can occur when the force is abruptly increased or as otherwise controlled. The increase in current causes faster heating and further plasticizing or softening of metal at the faying interface 190. In one embodiment, as indicated in FIG. 100, current flow is decreased to a point 315 after the offset 210 as the process enters the upset stage 330. The decrease in current during upset 330 is utilized to normalize or allow the material at the interface 190 to settle for certain types of AHSS materials such as complex-phase and boron grades of steels.

After the work pieces are forced into full contact during the offset, the pressure and high current continue causing further displacement along a path 216 which parallels a continuation 300 of path 310. This provides time for the softened metal at the interface to blend and relax.

As illustrated in FIGS. 2A, 2B, and 6, the upset stage 330 occurs following the offset 210. The first work piece is returned to its original acceleration rate of the original flashing curve 310 along curve 216 until the upset 330. As the upset stage 330 occurs, the work pieces are at least partially deformed at the faying interface 190 by applying pressure at an elevated level 222 when the metal at the interface has been heated to the plastic state. A portion of material from the heated and pressured faying interface 190 is squeezed out to allow the work pieces to join at the interface without chemical abnormalities or void spaces in the material along the weld joint 200. The rate of acceleration during the flashing stage 310, offset stage 210 and upset stage 330 is controlled by a processor and can be manipulated as needed by the computer readable medium having programmable software.

Additionally, the electrical potential may be continued for a brief time 270 after upset 330. After the weld is secure, but while the faying interface 190 is still relatively soft, excess extruded material 230, 240 is removed along the weld joint 200 as illustrated in FIG. 7. Here, tools 220 remove the excess material 230, 240 from the weld joint 200 to produce a finished surface along the faying interface 190.

The applied voltage is controlled by the controller 182 during the duration of the force freeze welding method. In one embodiment, a higher relative voltage 250 is applied during the linear translation 205 of the first work piece towards the second work piece prior to achieving arcing. The arcing acts to heat the faying interface 190 to soften or bring the phase of the material to a predetermined level of plasticity. After current flow is established, the applied voltage is reduced to a lower relative value through a substantial duration 260 of the flashing stage 310. The applied voltage is then raised to a higher predetermined level 270 at the beginning of the upset stage 330. This control condition is depicted by the Hi Contactor 250, 270 and Low Contactor 260 references in FIG. 2A. However, the flashing stage 310, the offset stage 210, and the upset stage 330 be performed with either a high relative voltage or a low relative voltage as a function of the chemistry of the material, the plasticity and a rate of reaching a desired plasticity of the work pieces. Additionally, variations in the carbon equivalent value of the materials also influence the programming and control features of the above-described force freeze method.

With reference to FIG. 8, the controller 182 is a processor that is programmed to control the position of the first work piece whether the apparatus that supports the work pieces is a hydraulic assembly or a servo drive assembly 152. The controller 182 is also programmed adjust the variable voltage source 142 to provide the electrical potential that is introduced to the circuit and the amount of both a voltage magnitude, ie, high or low, and the amount of amperage draw throughout the duration of the force freeze welding process. Additionally, the controller 182 is programmed to control the rate of displacement of the first work piece as it is positioned along the predetermined position path or curve. The position of both the offset 210 and the upset 330 along the curve is controlled and programmable in the processor based on chemical makeup of the members to be flash welded.

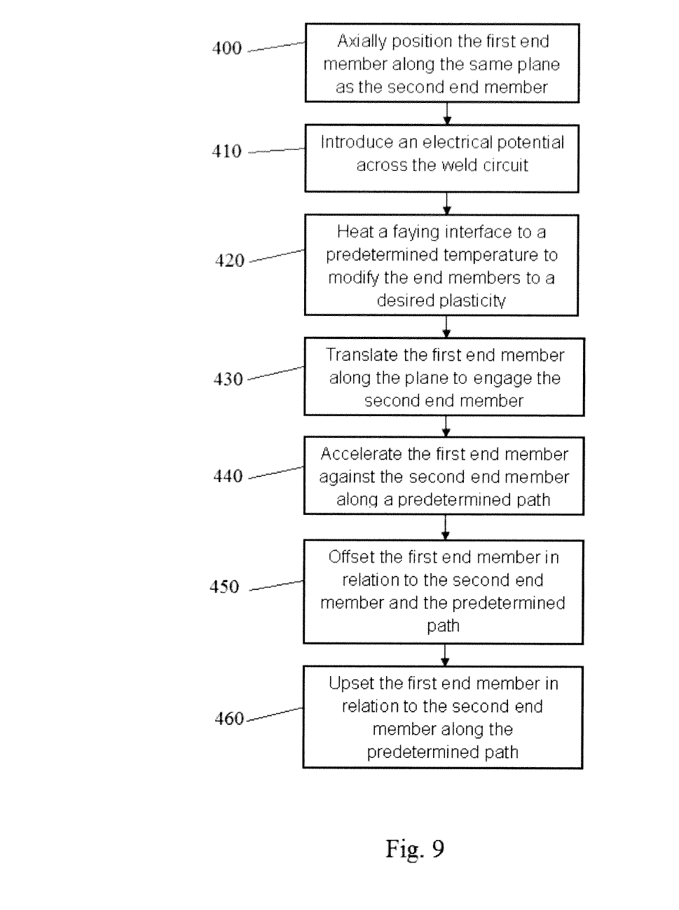

FIG. 9 provides a schematic diagram for one embodiment of the flash welding method. In a step 400, the first work piece is axially positioned with the second work piece along a common plane. In step 410, an electrical potential is applied. In step 420, the faying interface is heated to a predetermined temperature to modify the end members to a level of plasticity. In step 430, the first work piece is translated along the common plane to engage the second work piece. In step 440, the first work piece is accelerated against the second work piece along the predetermined path. In step 450, the first work piece is offset in relation to the second work piece spaced from the predetermined path. In step 460, the first work piece is upset against the second work piece along the predetermined path thereby joining and bonding the members along a weld joint.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A welding method comprising:
in a flash welding stage (300),
moving at least one of a first and a second work pieces (130, 140) towards the other while applying an electrical potential to cause flashing to heat soften a faying interface (190) of the first and second work pieces (130, 140);
in an offset stage (210),
abruptly forcing the work pieces (130, 140) into full contact,
after full contact of the work pieces (130, 140), advancing the work pieces (130, 140) together at a slower rate (216) while allowing a higher current to further heat soften the faying interface (190); and
upsetting the work pieces (130, 140) in an upset stage (330) which follows the offsetting stage.

2. The welding method according to claim 1, wherein the offset stage (330) includes rapidly forcing the first and second work pieces (130, 140) into intimate contact such that a portion of material (218) is extruded along the faying interface (190).

3. The welding method according to claim 1, further including:
increasing the electrical potential during the offset stage (210) and upset stage (330) causing elevated heating of the faying interface (190) such that a plasticity of the material is increased and a portion of material (218, 230, 240) is extruded from the faying interface (190).

4. The flash welding method according to claim 1, further including:
linearly, constant acceleration type, or exponentially increasing a pressure or force applied to compress the work pieces during the flashing stage (310);
increasing the pressure during the offset stage (210); and
further increasing the pressure during the upset stage (330).

5. The flash welding method according to claim 1, wherein the offset stage (210) occurs at a controllable position in time along a position path (310).

6. The welding method according to claim 1, further including:
controlling the offset stage (210) to occur during a time between 90%-99% of the time between initiation of the flashing stage (310) and the upset stage (330).

7. The welding method according to claim 1, wherein the offset stage (210) occurs between 2 seconds and 22 seconds after the flashing stage (310) begins.

8. The welding method according to claim 1, wherein linear translation of the first work piece (130) in relation to the second work piece (140) is described by a position path (300).

9. The welding method according to claim 1, wherein the faying interface (190) includes a surrounding localized area of a first surface (160) of the first work piece (130), a surrounding localized area of a second surface (170) of the second work piece (140), and an air space (180) disposed between the first surface (160) and the second surface (170).

10. The welding method according to claim 9, further including:
extruding material (230, 240) along the faying interface (190) during the offset stage (210) and again during the upset stage (330).

11. The welding method according to claim 1, further including:
removing excess material (230, 240) from the faying interface (190) after the upset stage.

12. A welding system comprising:
a first platen (110) and a second platen (120) for securing and translating a first work piece (130) and a second work piece (140);
driver (152) configured to cause a first platen (110) to translate towards the second platen (120);
voltage source (142) configured apply an electric potential across the work pieces (130, 140); and
a controller (182) programmed to control the driver (152) and voltage source (42) and perform the method according to claim 1.

13. A welding method for joining metal work pieces, the method comprising:
controlling translation of a positioning assembly (100) having a first work piece (130) aligned to a second work piece (140) along a faying interface (190), the positioning assembly (100) including at least a first platen (110) for securing the first work piece (130), a second static platen (120) for securing the second work piece (140), the positioning assembly (100) biasing the first work piece (130) and the second work piece (140) together along a position path (310);
controlling an electrical potential to a circuit including the first work piece (130), the second work piece (140) and the faying interface (190);
controlling relative movement of the first work piece (130) and the second work piece (140) along the position path (310);
controlling the relative movement to interrupt the position path (310) with an offset (210) compressive force when the first work piece (130) and the second work piece (140) abut each other at the faying interface (190) before causing a compressive force to cause an upset (330) along the position path (310); and
extruding material (230, 240) adjacent the faying interface (190).

14. The welding method of claim 13, wherein the current draw of the electrical potential increases during the offset (210).

15. The welding method of claim 14, wherein the offset (210) occurs between 4 seconds and 22 seconds after the first work piece (130) abuts the second work piece (140).

16. The welding method of claim 13, wherein the offset (210) position of the first work piece (130) and second work piece (140) is between 0.005 inches and 0.025 inches inward of a first surface (160) and a second surface (170), respectfully.

17. A system of flash welding metal work pieces together comprising:
a positioning assembly (100) including a translation device operable to linearly translate a first platen (110) securing a first work piece (130) toward a second static platen (120) securing a second work piece (140) along a common plane (150);
an electrical circuit including at least the first work piece (130), the second work piece (140) and an associated power source; and
a processor programmed to perform the method of claim 13.

18. A computer readable medium carrying software to control a processor to perform the method of claim 13.

19. A flash welding method for joining metal work pieces, the method comprising:
heating a first work piece (130) and a second work piece (140) disposed proximate to the first work piece (130) along a faying interface (190) with an electrical current;
moving the first work piece (130) and the second work piece (140) closer into contact;
squeezing (210) the first work piece (130) and the second work piece (140) into full contact; and
mechanically upsetting (330) the first and second work pieces.

20. A flash welding system comprising:
a positioning assembly (100) including a translation device operable to linearly translate a first platen (110) securing a first work piece (130) toward a second static platen (120) securing a second work piece (140) along a common plane (150);
an electrical circuit including at least the first work piece (130), the second work piece (140) and an associated power source; and
a controller (182) programmed to control:
the positioning assembly to position the first platen (110) securing a first work piece (130) adjacent the second work piece (140) along a faying interface (190);
biasing the first work piece (130) towards the second work piece (140);
the electric circuit to apply an electrical potential between the first work piece (130) and the second work piece (140) to cause flashing along the faying interface;
the positioning assembly to abuttingly force the first and second work pieces into full contact and the electrical circuit to increase an electrical current flowing between the first and second work pieces;
the positioning assembly to continue to force the first and second work pieces together; and
the positioning assembly to compressively force the work pieces together extruding material (230, 240) along the faying interface (190); and
the electrical circuit to terminate the current flow between the first and second work pieces.

21. The welding method according to claim 1, further including:
increasing or maintaining the electrical potential during the offset stage (210) and decreasing the electrical potential during the upset stage (330) to allow normalization of the material at the faying interface (190) of the first and second work pieces (130, 140).
